(19) United States
(12) Patent Application Publication
(10) Pub. No.: US 2011/0264762 A1
(43) Pub. Date: Oct. 27, 2011

(54) Method and Apparatus for Handling Different Path Structures in Multiple CDN Vendors

(75) Inventor: Yan Fu, Espoo (FI)

(73) Assignee: Nokia Corporation, Espoo (FI)

(21) Appl. No.: 12/784,205

(22) Filed: May 20, 2010

Related U.S. Application Data
(60) Provisional application No. 61/327,031, filed on Apr. 22, 2010.
(60) Provisional application No. 61/330,281, filed on Apr. 30, 2010.

(51) Int. Cl. G06F 15/16

(52) U.S. Cl. 709/217; 709/232

(57) ABSTRACT

An approach is provided for resolving a network address of one or more of items included in a request for web content based, at least in part, on location information. The network address of the items corresponds to at least one of a plurality of sources for retrieving the items. Resolving of the network address of the items is based at least in part on a persistent data element specifying pertinent location information.

### RELATED APPLICATIONS

This application claims priority of U.S. Provisional Application No. 61/327,031 filed Apr. 22, 2010 and U.S. Provisional Application No. 61/330,281 filed Apr. 30, 2010, which is incorporated herein by reference in its entirety.

### BACKGROUND

With myriads of network ready client devices available on the market today, including laptop computers, Smartphones and personal data assistants, the demand for fast, convenient access to content has never been greater. Content types typically accessed by a user via their client devices include web objects, media files, software, documents, real time media streams and other components of internet delivery. The sources, from which users demand such content by way of a webpage or other network interface, are large enterprises, web service providers, media companies, news broadcasters, etc. To accommodate this demand, content delivery networks are often employed by content providers to streamline the content access and delivery process.

A content delivery network (CDN) is a system of computers (e.g., servers) placed at various physical points in a network that contain copies of content. Specifically, CDNs host content on behalf of a content provider so that requests for access to content can be fulfilled by a server closer in proximity to the requesting client, rather than the central server of the content provider directly; thus maximizing bandwidth availability. Due the seamless nature of CDNs, the user is not even aware that their content request is redirected to a given CDN for fulfillment. Redirection of the request typically entails specifying the appropriate network path (e.g., URL) to the CDN in which the content is held. As there are many different CDNs that may be employed by a given content provider to accommodate varying geographically located users, they each also require their own means of network path designation and nomenclature in order to handle requests. Unfortunately, there is no convenient means of accounting for the different network path structures amongst CDNs that are dedicated to providing the same content in such a manner that ensures that requests are guided to the best (closest) available CDN solution.

### SOME EXAMPLE EMBODIMENTS

Therefore, there is a need for an approach to enable the resolution of network path structures for different content delivery networks to fulfill a content request.

According to one embodiment, a method comprises receiving a request, from a device, for web content. The method also comprises determining location information associated with the device. The method further comprises resolving a network address of one or more of items included in the web content based, at least in part, on the location information.

According to another embodiment, an apparatus comprises at least one processor. The apparatus also comprises at least one memory including computer program code, the at least one memory and the computer program code configured to, with the at least one processor, cause the apparatus to receive a request, from a device, for web content. The apparatus is also caused to determine location information associated with the device. The apparatus is further caused to resolve a network address of one or more of items included in the web content based, at least in part, on the location information.

According to another embodiment, a computer-readable storage medium carrying one or more sequences of one or more instructions which, when executed by one or more processors, cause an apparatus to receive a request, from a device, for web content. The apparatus is also caused to determine location information associated with the device. The apparatus is further caused to resolve a network address of one or more of items included in the web content based, at least in part, on the location information.

According to another embodiment, an apparatus comprises means for causing, at least in part, receiving of a request, from a device, for web content. The apparatus further comprises means for determining a location information associated with the device. The apparatus further comprises means for causing, at least in part, resolving of a network address of one or more of items included in the web content based, at least in part, on the location information.

Still other aspects, features and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system for enabling the resolution of network path structures for different content delivery networks to fulfill a content request, according to one embodiment;

FIG. 2 is a high-level flowchart depicting the process for enabling the resolution of network path structures for different content delivery networks to fulfill a content request, according to one embodiment;

FIG. 3 is a diagram depicting the interaction occurring between elements of the system for enabling the resolution of network path structures for different content delivery networks to fulfill a content request, according to one embodiment;

FIG. 4 is a flowchart of the process for determining a network path structure for the fulfillment of a content request, according to one embodiment;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus, and computer program for enabling the seamless resolution and selection of network address information for content delivery networks. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

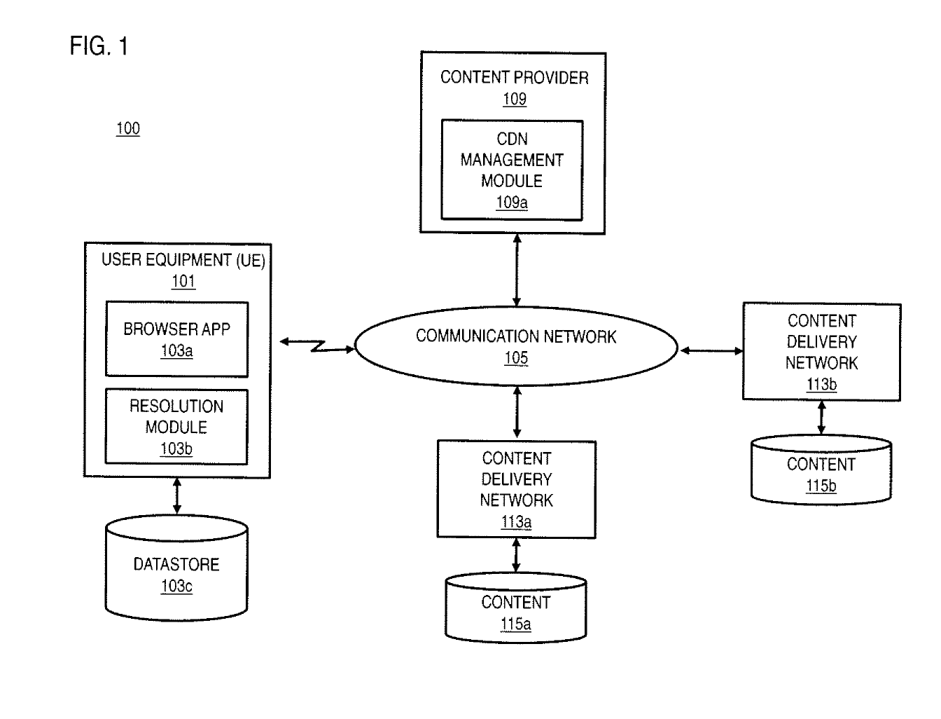

FIG. 1 is a diagram of a system for enabling the resolution of network path structures for different content delivery networks to fulfill a content request, according to one embodiment. As used herein, “network path structures” refer to any specific nomenclature, syntax, instructions, file location or network address from whence content can be accessed. A specified network path is critical for enabling content to be accessed (e.g., downloaded or retrieved) by one or more retrieving content delivery networks or the like on behalf of requesting user equipment (UE) 101. As mentioned before, content including, but not limited to audio, video, streaming media, documents, images, software applications, applets, web services, executables, etc., is regularly requested by users as they engage a given content provider's website or other hosted application. The delivery of content on demand at the request of a user's UE 101 is critical to enabling the user experience. For example, the ability of the user to review a streaming video or graphic image depicting a product of interest at the host website can influence the user's buying decision.

Content delivery networks (CDNs) 113 comprise a network of computers (e.g., servers) that are designed to ensure efficient delivery of content 115. The servers of a given content delivery network 113 are geographically dispersed, with content being replicated across each. In this way, when a user requests to download content 115, the CDN finds a server that is located nearest to the user equipment 101 from which the download request was made. So, for example, a user operating a browser application located in China would preferably access data from a CDN or a respective server thereof that is also in China as opposed to one in the United States. Exemplary content delivery service providers include, but are not limited to, Akamai, Coral Content Distribution Network, AppStream, EdgeCast Networks, Bit Torrent, etc.

In addition to location and proximity considerations, other criteria may also be exercised as well by the CDN in determining which server is to fulfill the request, including but not limited to network load conditions, server availability, current or historical traffic levels, content type to be retrieved, etc. In effect, the original backend server for the Internet Service that owns the content item is not directly involved at all. However, given the number of different CDN vendors (e.g., 113a and 113b) all possessing content at different network/geographic locations, a means of resolving differences in path structures for the calling of content must be exercised. This is especially true in instances where a content provider 109, say a consumer sporting goods store, wishes to add a new CDN provider (not shown) to host some of its content. If the network path structure to that content has already been allocated to the other CDNs 113a and 113b, the newly added CDN cannot be utilized effectively, even if it is the best suitor for a given user's location.

With this in mind, the system 100 features various additional components that enable network path structures to be readily accounted for and selected to optimize the user experience. User equipment (UE) 101 has connectivity to the content provider 103 via a communication network 105 and a browser application 103a. As an example, the browser application 103a allows the UE 101 to exchange or share data over the network 105 with content provider 109. The data can be any content, information or applications intended to be stored to a datastore 103c upon retrieval or presented to a display of the user equipment within the browser 103a. The browser 103a can be a dedicated media management application (e.g., a web service application), an internet browser from whence the user may establish a session with the content provider 109 or the like.

In general, the browser 103a and the content provider 109 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The content provider 109 pertains to any hosted (or even client/server based) applications intended to promote the exchange and/or presentment of data to requesting user equipment 101. Content providers include websites, application server sites, social networking sites, media services providers, information broadcasting sites, etc. In accord with the embodiment, the content provider executes a CDN management module 109a. The CDN management module 109a performs functions including but not limited to, (1) passing a persistent data element, i.e., a tracking or browsing cookie, to the user equipment 101 in response to a received user request and (2) maintaining data regarding one or more CDNs 113a/113b in which content is stored. Data maintained regarding the content stored by a CDN 113a/113b may include, but is not limited to, the specific content type, size and duration as maintained by a respective CDN. Additional data maintained by the CDN management module 109a regarding the network conditions of content sources (CDNs 113a/113b) includes, but is not limited to, respective IP addresses of a given CDN, a resource load, a network traffic load, a bandwidth capacity and a processing capacity associated with respective CDNs.

Still further, the CDN management module 109a can maintain data pertaining to the requesting client device, including but not limited to data specifying a network address of the device, a country of origin of the device, a location of the device, or a combination thereof. As will be discussed subsequently, the various data maintained by the CDN management module 109a can also be encoded within a persistent data element, such as a cookie implemented as a text file, and passed onto requesting user equipment 101. As capabilities and content providers differ vastly, however, so too does the type of content they provide. Hence, any platform for facilitating the sharing of content, whether it is graphical, media, textual, instructional or of any other form is within the scope of the inventive concepts presented herein. Also, differing content providers need not implement a CDN management module 109a in the same manner and function as presented above. At a minimum, the CDN management module 109a passes along a persistent data element, e.g. cookie, specifying at least in part, a network address of the device, a country of origin of the device, a location of the device or a combination thereof.

With respect to the UE 101, a resolution module 103b also operates in connection with the browser application 103a. The resolution module possesses the necessary logic for resolving which CDN 113a/113b vendor/path to direct an HTTP Get request or other communication protocol content request to a CDN based, at least in part, on the location info specified in the persistent data element (e.g., cookie). Specifically, the resolution module 103b is able to render a network address that indicates at least a specific CDN 113 to access data from, a network path to the data and the name of the content to be accessed, as in exemplary format http://<cdn>/<path-default>/<content.*>. As an example, consider the returned URL http://cdn113a/path113a/dogphoto.gif, where the specified CDN corresponds to 113a, path to the content 115a is path 113a and the content to be accessed from 115a is “dogphoto.gif.” Of course, other network address and path syntaxes and nomenclatures may also apply.

In general, the UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.). Moreover, the UE 101 may execute one or more software applications or utilities, some of which operate in connection with the browser application 103a. These include but are not limited to those for enabling or facilitating network access and communication, performing social networking, e-mail communication, file sharing and data transfer, word processing, data entry, spreadsheet processing, mathematical computation, word processing, etc.

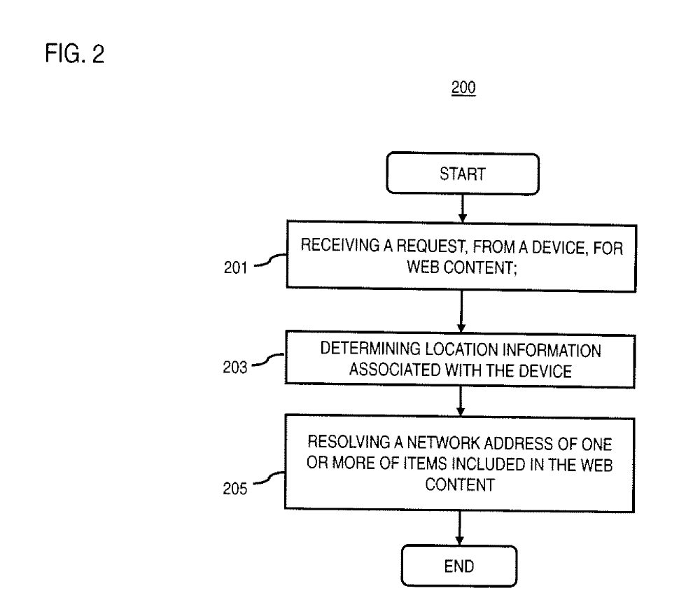

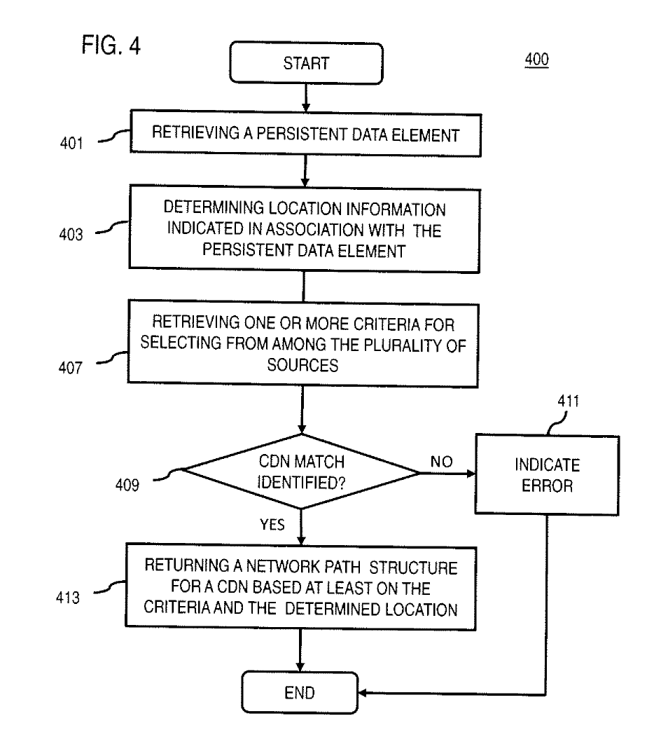

Attention is now turned to FIG. 2, a high-level flowchart depicting the process for enabling the resolution of network path structures for different content delivery networks to fulfill a content request, according to one embodiment. As a first step 201, the content provider 109 receives a request for specific web content from a user of UE 101. This request is initiated for example via usage of a browser application 103a, wherein the user is attempting to access a specific webpage featuring content associated with or provided by the content provider 109. The request message may include information referencing the location of the browser/user equipment of origination—i.e., network location such as IP Address or physical location such as city, country or zip. The content provider 109, in conjunction with the CDN management module 109a, determines the network and or physical whereabouts of the browser or client device from which the request originated based on this data. This corresponds to step 403 of FIG. 4, as will be discussed later on.

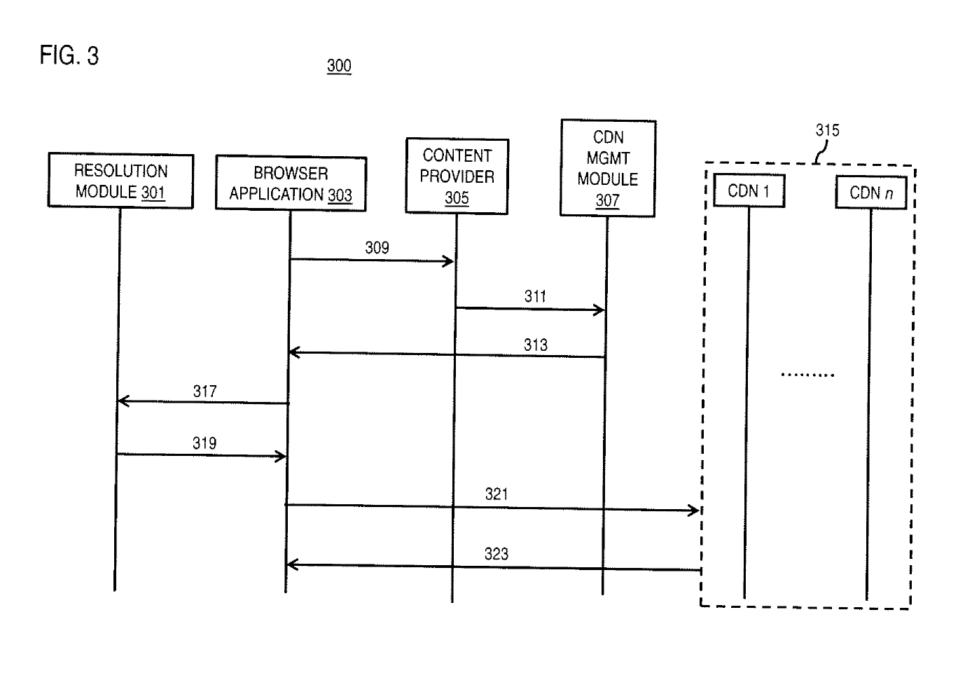

As a final step 205, a network address of one or more items included in the requested web content 405 is resolved. In particular, the network address of the items corresponds to at least one of a plurality of sources, namely CDNs, for retrieving the items. The final step of resolution 205, as presented in this high-level flowchart embodiment, is executable by the content provider 109 in conjunction with the CDN management module 109a or by the browser 103 operating on the user equipment 103 in conjunction with the resolution module 103b. In accord with one embodiment, FIG. 3 is a diagram depicting the interaction occurring between elements of the system for enabling the resolution of network path structures for different content delivery networks to fulfill a content request. In this embodiment, the resolution step 205 is executed by the user equipment.

As a first interaction, the browser application engages a content provider 305 by way of request for access to or retrieval of content, this interaction or task corresponding to arrow 309. Consider, for example, a scenario wherein the browser application is used to request a page referencing a content provider at URL/network address http://ovistore/index.php, in this case Ovi Store. The page includes various images, including an image referenced by URL/network address http://cdn/path-default/logo.gif. In the response to the request, the content provider 305 Ovi Store passes the request header information to its CDN management module 307, corresponding to interaction or task 311.

Having processed the request info, the CDN management module 307 formulates a persistent data element, i.e. a cookie that includes at least the IP address or country of the browser application 303. Alternatively or in addition, the cookie can include other data as described above, including data pertaining to the content maintained by various CDN options 315, shown herein as CDN1 to CDN n. Still further, other data for inclusion in the cookie can include data pertaining to network conditions of the CDNs 315. Once formulated, the cookie is passed to the requesting browser, corresponding to interaction or task 313.

Once received, the cookie is stored to a datastore 103c and/or passed onto the resolution module 301, corresponding to interaction or task 317. The resolution module 301 then uses the information provided in the cookie to resolve/render a URL appropriate for enabling access to the specified content by way of one of the CDN vendors 315. In the example scenario, the content desired is “logo.gif.” Assuming the browser of request origination is in China, the URL would be, for example, http://chinacdn/path2/logo.gif, where the specific CDN from amongst the options 315 is China CDN. If the location information specifies a different location, however, or some other criteria is analyzed to deem it appropriate, a different URL indicating a different CDN is rendered (e.g., http://bignetwork/path1/logo.gif, where the CDN from amongst the options 315 is a CDN vendor known as Big Network). Having resolved the resolved network address, this URL is provided to the browser application 303, where the browser then proceeds to download the image directly from the selected CDN. This corresponds to interactions or tasks 319 and 321 respectively.

As a final interaction or task 323, the selected CDN from amongst the various options 315 return to the browser application 303 the specified content. This content is presented within the browser application 303 accordingly. Of particular importance to the user of the browser application 303 and user equipment from whence the initial content request originated is that the above described interactions occur seamlessly and quickly with no required action by the user beyond the point of request initiation 309.

FIG. 4 is a flowchart detailing the process for determining a network path structure for the fulfillment of a content request, according to one embodiment. In particular, this execution is performed by the resolution module 301. As a first and second step 401 and 403 respectively, the persistent data element is retrieved and analyzed to determine location information as indicated therein. The location information can be the network or physical location of the browser, an IP address corresponding to one or more available servers of the CDN, network address of the device, a country of origin of the device, a location of the device, or a combination thereof.

As a next step 405, the resolution module 301 retrieves one or more criteria data for selecting from among the plurality of content resources available. These criteria can include, as indicated earlier, resource or network traffic load, content type and size, and other factors associated with the originating request. Such criteria data can be provided, for example, by way of the cookie passed onto the user equipment. Alternatively, this data can be perceived through auxiliary sensing techniques (e.g., spatiotemporal detection, GPS data), provided by a third party application or presented by way of known network probing techniques (e.g., pinging).

Using the determined location information along with any applicable criteria data, an analysis is performed corresponding to step 409 to determine which CDNs match the request within the context of the needed content, proximity considerations, network conditions, etc. If a match is determined, a network path structure for a CDN based at least on the criteria and the determined location information is generated and returned to the browser application for use in communicating with the necessary CDN. Otherwise, an error message is presented to the browser, corresponding to no resulting content being displayed. It is common in such instances where no content could be rendered to be presented to the browser as a blank area, an error box, a textual description (tag) but no actual graphic or other media, etc. The above describe steps correspond to 411 and 413 accordingly.

An exemplary pseudocode structure depicting means for executing the above described processes, through means of a browser or other network executable application, is presented below for example purposes. It will be recognized, however, that various implementations and approaches may be applied and the example does not limit the scope, range of execution or application of the concepts and techniques presented herein.

<<Start source code>>
//PSEUDOCODE FOR RETRIEVING A COOKIE OF A SPECIFIED
NAME (“name of cookie”)
FUNCTION: getCookie (“name of cookie”)

Determine if the cookie is > 0 bits of data (meaning it exists)

If so, copy the contents of the cookie from start to finish to a
buffer
Return copied results
End

//PSEUDOCODE FOR SELECTING A SPECIFIC URL TO INVOKE
FUNCTION: transform (“specific URL”)

Determine if contents of cookie corresponds to IP Address #1 (e.g.,
“192.168.217.135”)

If yes, include the URL corresponding to this IP Address in the
network path

Otherwise, determine if contents of cookie correspond to IP Address
#2 (e.g., “192.168.217.134”)

If yes, include the URL corresponding to this IP Address in the
network path

.
.
.
Otherwise, determine if contents of cookie correspond to IP Address
#n (e.g., “192.168.xxx.xxx”)

If yes, include the URL corresponding to this IP Address in the
network path

Otherwise, just return the default network path/URL
End

//PSEUDOCODE FOR RETRIEVING CONTENT FROM A CONTENT
SOURCE AT A SPECIFIED URL/NETWORK PATH
FUNCTION: getContent (“specific location of content”)

Goto the specified URL/network path from which content is to be
retreived (invoke results of transform(“specific URL”)
Indicate “specific location of content” from the URL/network path

If content found, return; embed in calling webpage
If not found, indicate that media could not be found

End

<<End source code>>

The above presented examples present a convenient means for resolving the obstacles inherent when content has to be hosted in different path structures in different CDN vendors. Moreover, the above described approach allows a CND management module of a given content provider to be more readily integrated with newly added CDN vendors. Still further, the examples, if implemented as presented, provide a means for creating a unified/normalized path structure process suitable for interaction with any CDN vendor.

The processes described herein may be advantageously implemented via software, hardware, firmware or a combination of software and/or firmware and/or hardware. For example, the processes described herein, including for providing user interface navigation information associated with the availability of services, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

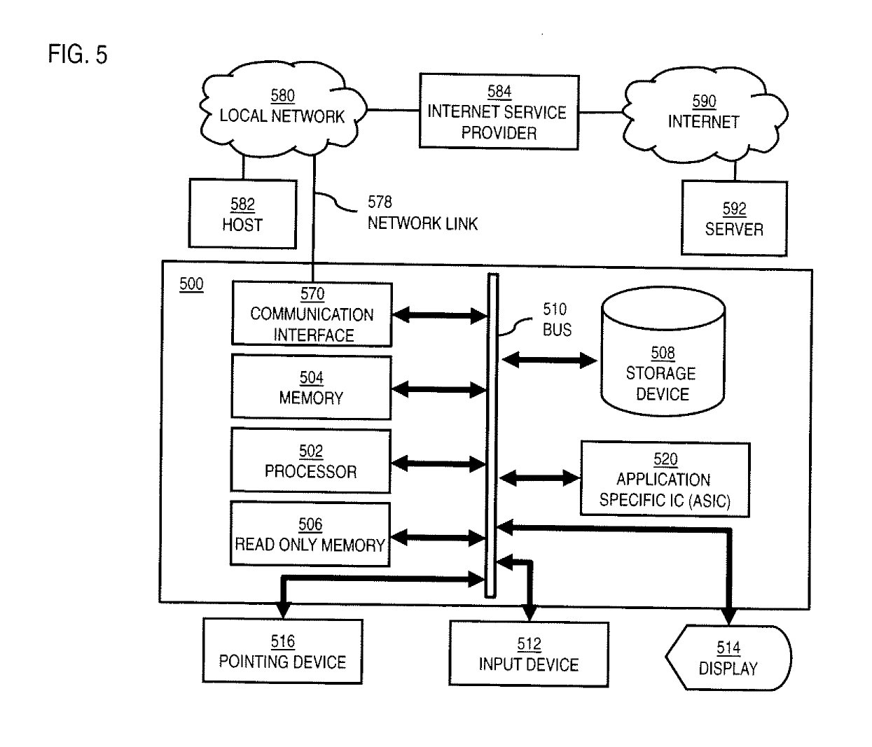

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to enabling the resolution of network path structures for different content delivery networks to fulfill a content request as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of enabling the resolution of network path structures for different content delivery networks to fulfill a content request.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to enabling the resolution of network path structures for different content delivery networks to fulfill a content request. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or other dynamic storage device, stores information including processor instructions for enabling the resolution of network path structures for different content delivery networks to fulfill a content request. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for enabling the resolution of network path structures for different content delivery networks to fulfill a content request, is provided to the bus 510 for use by the processor from an external input device 512, such as a keyboard containing alphanumeric keys operated by a human user, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT) or a liquid crystal display (LCD), or plasma screen or printer for presenting text or images, and a pointing device 516, such as a mouse or a trackball or cursor direction keys, or motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of application specific ICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for enabling the resolution of network path structures for different content delivery networks to fulfill a content request to the UE 101.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

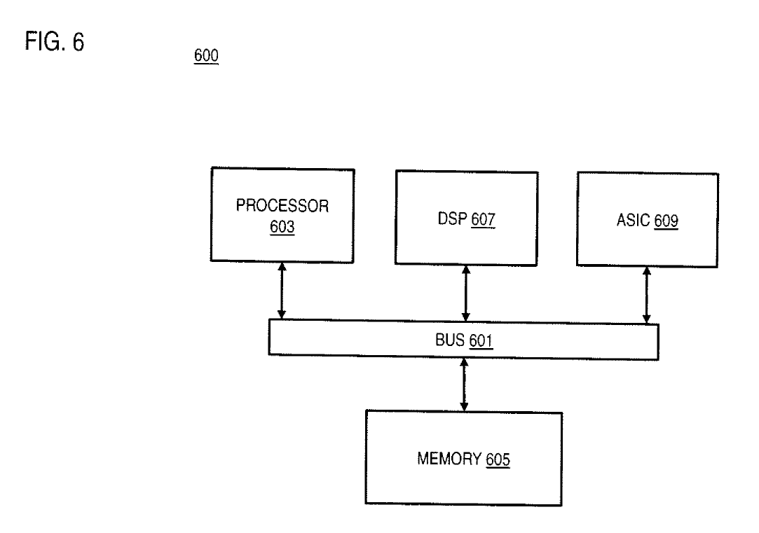

FIG. 6 illustrates a chip set or chip 600 upon which an embodiment of the invention may be implemented. Chip set 600 is programmed to enabling the resolution of network path structures for different content delivery networks to fulfill a content request as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of services. Chip set or chip 600, or a portion thereof, constitutes a means for performing one or more steps of enabling the resolution of network path structures for different content delivery networks to fulfill a content request.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to enabling the resolution of network path structures for different content delivery networks to fulfill a content request. The memory 605 also stores the data associated with or generated by the execution of the inventive steps.

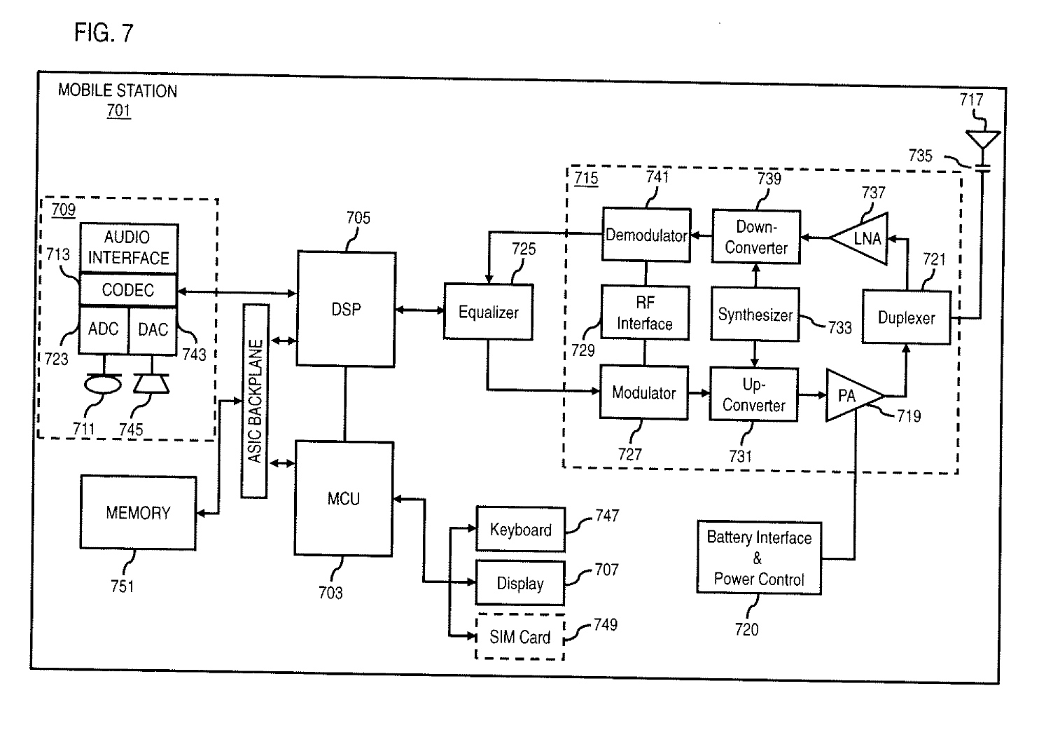

FIG. 7 is a diagram of exemplary components of a mobile terminal (e.g., handset) for communications, which is capable of operating in the system of FIG. 1, according to one embodiment. In some embodiments, mobile terminal 700, or a portion thereof, constitutes a means for performing one or more steps of enabling the resolution of network path structures for different content delivery networks to fulfill a content request. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of enabling the resolution of network path structures for different content delivery networks to fulfill a content request. The display 7 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703—which can be implemented as a Central Processing Unit (CPU) (not shown).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to enabling the resolution of network path structures for different content delivery networks to fulfill a content request. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A method comprising:
receiving a request, from a device, for web content;
determining location information associated with the device; and
resolving a network address of one or more of items included in the web content based, at least in part, on the location information,
wherein the network address of the items corresponds to at least one of a plurality of sources for retrieving the items.

2. A method of claim 1, further comprising:
causing, at least in part, storage of a persistent data element at the device, the persistent data element specifying, at least in part, a network address of the device, a country of origin of the device, a location of the device, or a combination thereof,
wherein the resolving of the network address of the items is further based, at least in part, on the persistent data element.

3. A method of claim 2, wherein the persistent data element is a cookie.

4. A method of claim 1, further comprising:
retrieving one or more criteria for selecting from among the plurality of sources,
wherein the resolving of the network address is based, at least in part, on the criteria.

5. A method of claim 4, wherein the criteria relate to characteristics of the items including, at least in part, an item type, an item size, an item duration, or a combination thereof.

6. A method of claim 4, wherein the criteria relate to characteristics of the plurality of sources including, at least in part, a resource load, a network traffic load, a bandwidth capacity, a processing capacity, or a combination thereof.

7. A method of claim 1, wherein the location information is determined from sensors of the device, external location-based services, or a combination thereof.

8. A method of claim 1, wherein the plurality of sources have different path structures for specifying the network address of the items.

9. An apparatus comprising:
at least one processor; and
at least one memory including computer program code,
the at least one memory and the computer program code configured to, with the at least one processor, cause the apparatus to perform at least the following,
receive a request, from a device, for web content;
determine location information associated with the device; and
resolve a network address of one or more of items included in the web content based, at least in part, on the location information,
wherein the network address of the items corresponds to at least one of a plurality of sources for retrieving the items.

10. An apparatus of claim 9, wherein the apparatus is further caused to:
cause, at least in part, storage of a persistent data element at the device, the persistent data element specifying, at least in part, a network address of the device, a country of origin of the device, a location of the device, or a combination thereof,
wherein the resolving of the network address of the items is further based, at least in part, on the persistent data element.

11. An apparatus of claim 10, wherein the persistent data element is a cookie.

12. An apparatus of claim 9, wherein the apparatus is further caused to:
retrieve one or more criteria for selecting from among the plurality of sources,
wherein the resolving of the network address is based, at least in part, on the criteria.

13. An apparatus of claim 12, wherein the criteria relate to characteristics of the items including, at least in part, an item type, an item size, an item duration, or a combination thereof.

14. An apparatus of claim 12, wherein the criteria relate to characteristics of the plurality of sources including, at least in part, a resource load, a network traffic load, a bandwidth capacity, a processing capacity, or a combination thereof.

15. An apparatus of claim 9, wherein the location information is determined from sensors of the device, external location-based services, or a combination thereof.

16. An apparatus of claim 9, wherein the plurality of sources have different path structures for specifying the network address of the items.

17. An apparatus of claim 9, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

18. A computer-readable storage medium carrying one or more sequences of one or more instructions which, when executed by one or more processors, cause an apparatus to at least perform the following steps:
receiving a request, from a device, for web content;
determining location information associated with the device; and
resolving a network address of one or more of items included in the web content based, at least in part, on the location information,
wherein the network address of the items corresponds to at least one of a plurality of sources for retrieving the items.

19. A computer-readable storage medium of claim 18, wherein the apparatus is caused to further perform:
causing, at least in part, storage of a persistent data element at the device, the persistent data element specifying, at least in part, a network address of the device, a country of origin of the device, a location of the device, or a combination thereof,
wherein the resolving of the network address of the items is further based, at least in part, on the persistent data element.

20. A computer-readable storage medium of claim 18, wherein the apparatus is caused to further perform:
retrieving one or more criteria for selecting from among the plurality of sources,
wherein the resolving of the network address is based, at least in part, on the criteria.

21-54. (canceled)
